(19) United States
(12) Patent Application Publication
(10) Pub. No.: US 2015/0309828 A1
(43) Pub. Date: Oct. 29, 2015

(54) HYPERVISOR MANAGER FOR VIRTUAL MACHINE MANAGEMENT

(71) Applicants: Nisaruddin Shaik, Bangalore (IN); Satish Kumar Govindaraju, Bangalore (IN); Prithvi Venkatesh, Bangalore (IN)

(72) Inventors: Nisaruddin Shaik, Bangalore (IN); Satish Kumar Govindaraju, Bangalore (IN); Prithvi Venkatesh, Bangalore (IN)

(73) Assignee: Unisys Corporation, Blue Bell, PA (US)

(21) Appl. No.: 14/534,294

(22) Filed: Nov. 6, 2014

(30) Foreign Application Priority Data
Apr. 24, 2014 (IN) 1116/DEL/2014

(51) Int. Cl. G06F 9/455; G06F 9/50

(52) U.S. Cl. CPC G06F 9/45558; G06F 9/5027; G06F 2009/4557

(57) ABSTRACT

Adaptive virtual servers with hypervisor managers may be used to manage several hypervisors, including hypervisors of different types. An adaptive virtual server may monitor resource utilization of virtual machines and dynamically assign resources to the virtual machines. Dynamic allocation of resources may improve efficiency for usage of available resources and improve performance of the virtual machines. Further, an adaptive virtual server may allocate resources to a virtual machine from multiple hypervisors, including hypervisors of different types.

### FIELD OF DISCLOSURE

The instant disclosure relates to virtual machine management. More specifically, this disclosure relates to managing resources of virtual machines on hypervisors.

### BACKGROUND

Virtual machines are simulated computers executing on a physical computer system. For example, a first virtual machine executing a first operating system and a second virtual machine executing a second operating system may be simulated on a single physical computer system. The computer system, although only having a single processor, a single random access memory (RAM), and a single disk storage device, may create virtual resources for use by the virtual machines. The computer system then schedules the use of the physical resources of the computer system between the virtual resources. For example, the computer system may create two virtual processors for use by the first virtual machine and the second virtual machine and combine operations from the first virtual machine and the second virtual machine for execution by the single processor of the physical computer system. The virtual machines may be created and managed by a software program referred to as a hypervisor on the computer system. The use of virtual machines may allow multiple people to share the resources of a single computer system and thus reduce costs.

FIG. 1 is a block diagram illustrating a conventional hypervisor system for hosting virtual machines. A hypervisor 110 may have access to a processor 102, a memory 104, and a disk 106. Virtual machines 112 and 114 may be hosted by the hypervisor 110 and allowed access to portions of the processor 102, the memory 104, and the disk 106. That is, the hypervisor 110 may emulate multiple computers for the virtual machine 112 and 114 by using only a single set of resources (the processor 102, the memory 104, and the disk 106).

Datacenters having multiple computer systems and multiple hypervisors may be created to allow creation of many virtual machines. However, maintaining these data centers may become a large administrative act. Further, sharing of resources between the hypervisors is not possible. Thus, a virtual machine only has access to resources for the hypervisor that created the virtual machine. Not sharing resources between hypervisors reduces efficiency of resource utilization. For example, one hypervisor may be executing live very busy virtual machines while another hypervisor executes two idle virtual machines. Further, administrators and users of the data center do not get the benefits of best features available across the hypervisors in the data center.

### SUMMARY

Adaptive virtual servers with hypervisor managers may be used to manage several hypervisors, including hypervisors of different types. An adaptive virtual server may monitor resource utilization of virtual machines and dynamically assign resources to the virtual machines. Dynamic allocation of resources may improve efficiency for usage of available resources and improve performance of the virtual machines. Further, an adaptive virtual server may allocate resources to a virtual machine from multiple hypervisors. This may further improve efficiency and performance.

According to one embodiment, an apparatus may include a memory and a processor coupled to the memory. The processor may be configured to execute the steps comprising monitoring the utilization of resources of a virtual machine executing on at least one hypervisor with assigned resources, and instructing the at least one hypervisor to modify the assigned resources for the virtual machine based, at least in part, on the monitored utilization of the assigned resources.

According to another embodiment, a computer program product may include a non-transitory computer readable medium comprising code to perform the steps of monitoring the utilization of resources of a virtual machine executing on at least one hypervisor with assigned resources, and instructing the at least one hypervisor to modify the assigned resources for the virtual machine based, at least in part, on the monitored utilization of the assigned resources.

According to yet another embodiment, a method may include monitoring, by an adaptive virtual server, the utilization of resources of a virtual machine executing on at least one hypervisor with assigned resources; and instructing, by the adaptive virtual server, the at least one hypervisor to modify the assigned resources for the virtual machine based, at least in part, on the monitored utilization of the assigned resources.

According to another embodiment, an apparatus may include a hypervisor manager coupled to at least one hypervisor and in communication with at least one virtual machine. The hypervisor manager may be configured to assign resources from the at least one hypervisor to the at least one virtual machine. The hypervisor manager may include a resource registry module configured to store a listing of resources available on the at least one hypervisor and a resource analyzer module configured to receive resource utilization information of the at least one virtual machine.

According to yet another embodiment, an apparatus may include an adaptive virtual server coupled to at least one hypervisor. The adaptive virtual server may be configured to receive a request to create a virtual machine, determine a set of resources for the virtual machine on the at least one hypervisor, and create the virtual machine with the determined set of resources.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional hypervisor system for hosting virtual machines.

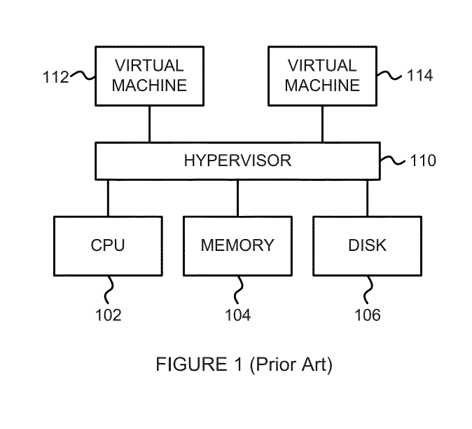

FIG. 2 is a flow chart illustrating a method for managing resources of a virtual machine with an adaptive virtual server according to one embodiment of the disclosure.

FIG. 3 is a flow chart illustrating a method for increasing or decreasing resources of a virtual machine with an adaptive virtual server based on predetermined thresholds according to one embodiment of the disclosure.

FIG. 4 is a block diagram illustrating an adaptive virtual server according to one embodiment of the disclosure.

FIG. 5 is a block diagram illustrating a hypervisor manager according to one embodiment of the disclosure.

FIG. 6 is a block diagram illustrating communication between portions of a hypervisor manager and sensors according to one embodiment of the disclosure.

FIG. 7 is a block diagram illustrating assigning of resources from multiple hypervisors to a virtual machine through an adaptive virtual server according to one embodiment of the disclosure.

FIG. 8 is a block diagram illustrating assigning bandwidth to virtual machines through an adaptive virtual server according to one embodiment of the disclosure.

FIG. 9 is a flow chart illustrating a method of assigning bandwidth to a virtual machine according to one embodiment of the disclosure.

FIG. 10 is a block diagram illustrating clustering of hypervisor managers according to one embodiment.

FIG. 11 is a block diagram illustrating a computer network according to one embodiment of the disclosure.

FIG. 12 is a block diagram illustrating a computer system according to one embodiment of the disclosure.

### DETAILED DESCRIPTION

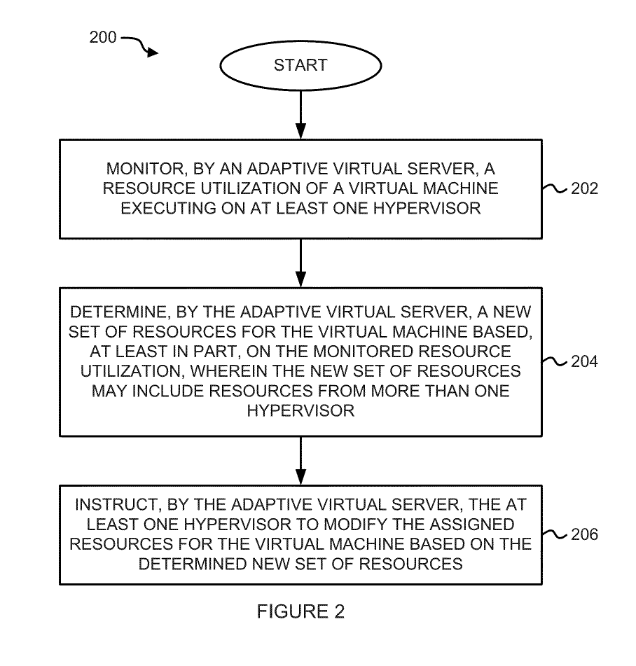

FIG. 2 is a flow chart illustrating a method for managing resources of a virtual machine with an adaptive virtual server according to one embodiment of the disclosure. Resources may be dynamically assigned from hypervisors to virtual machines by an adaptive virtual server based, for example, on the resource utilization of the virtual machines. Dynamically assigning the resources allows for more efficient use of the resources available on the hypervisor. For example, by de-assigning resources from virtual machines with low resource utilization, the resources may be freed up for other virtual machines. In another example, assigning additional resources to virtual machines may allow the virtual machines to complete tasks faster. Then, the additional resources may be de-assigned from the virtual machine when the tasks are complete.

A method 200 for dynamic assignment of hypervisor resources may begin at block 202 with monitoring, by an adaptive virtual server, a resource utilization of a virtual machine executing on at least one hypervisor. The monitoring may be performed by, for example, a monitor within the adaptive virtual server, a monitor within the virtual machine, and/or a monitor on the hypervisor. The monitors may monitor resource utilization, such as by tracking processor usage, random access memory (RAM) usage, and/or disk usage. The monitoring may be performed directly, such as by directly accessing statistics in the virtual machine, or indirectly, such as by monitoring data input/output of the virtual machine and calculating an approximate processor usage, RAM usage, and/or disk usage.

At block 204, the adaptive virtual server may determine a new set of resources for the virtual machine based, at least in part, on the monitored resource utilization. For example, when monitored resource utilization of block 202 is high, the new set of resources for the virtual machine may include additional processor capacity, RAM memory, and/or disk storage space. In particular, if processor utilization over a previous predefined time period averaged in excess of a predetermined threshold, additional processors and/or additional processor time may be assigned to the virtual machine. In one embodiment, the new set of resources may include resources from more than one hypervisor. In particular, the multiple hypervisors providing resources for the virtual machine in the new set of resources may be different types of hypervisors. In another example, when monitored resource utilization of block 202 is low, the new set of resources for the virtual machine at block 204 may include reduced processor capacity, RAM memory, and/or disk storage space. Further, when monitored resource utilization of block 202 remains approximately constant, the new set of resources may be set as the current set of resources for the virtual machine.

At block 206, the adaptive virtual server may instruct the at least one hypervisor executing the virtual machine to modify the assigned resources for the virtual machine based, at least in part, on the determined new set of resources at block 204. The adaptive virtual server may transmit the instructions to the hypervisors through one or more hypervisor managers.

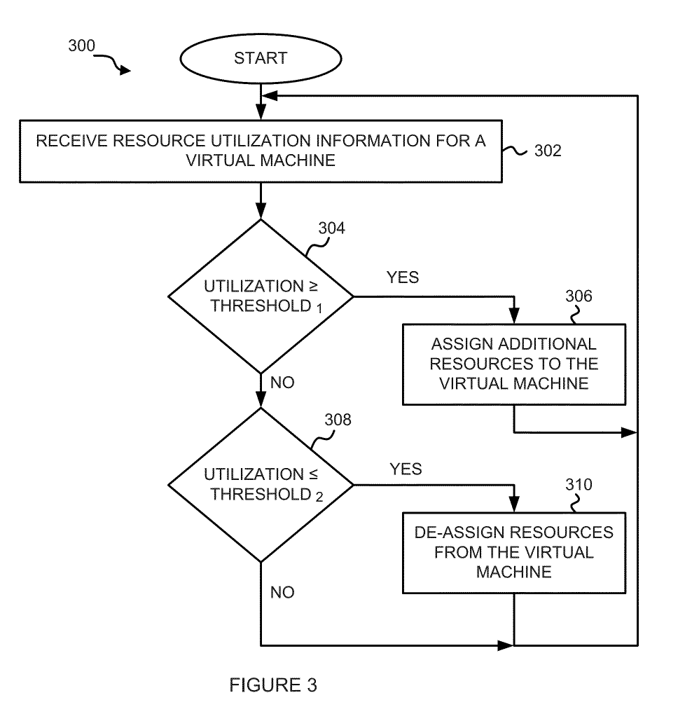

The determination of the new set of resources at block 204 may be performed by comparing monitored resource utilization of block 202 to predetermined thresholds for increasing or decreasing resources assigned to a virtual machine. FIG. 3 is a flow chart illustrating a method for increasing or decreasing resources of a virtual machine with an adaptive virtual server based on predetermined thresholds according to one embodiment of the disclosure. A method 300 for assigning a new set of resources to a virtual machine may begin at block 302 with receiving resource utilization information for a virtual machine. In one embodiment, the received resource utilization information may be an instantaneous value for processor utilization, RAM usage, and/or disk storage usage. The instantaneous values may be averaged over time for comparison to thresholds at blocks 304 and 306 described below. In another embodiment, the received resource utilization information may be an average value that is used for comparison to thresholds at blocks 304 and 306.

At block 304, it is determined whether the received resource utilization information of block 302 indicates utilization exceeding a first threshold. If the first threshold is exceeded then additional resources may be assigned to the virtual machine at block 306 in the new set of resources. In one embodiment, the comparison of block 304 may separately compare processor utilization, RAM usage, disk space usage, and/or other resource utilization with different thresholds and assign additional resources corresponding to the resources that exceed the threshold. For example, if processor utilization is above a first processor utilization threshold and RAM usage is above a first RAM usage threshold but disk space usage is not above a first disk space usage threshold, the only additional processor and RAM resources may be assigned at block 306. In another embodiment, the comparison of block 304 may separate compare each resource with a corresponding threshold. However, additional resources may be assigned to the virtual machine for multiple resources if only one resource utilization exceeds the threshold. For example, several resource profiles may be defined including a high profile, a medium profile, and a low profile, with corresponding levels of processor resources, RAM resources, and disk space resources. When the virtual machine is executing with a medium profile and any one of the resource utilizations exceeds the threshold, then the virtual machine may be assigned the high profile.

If the first threshold is not exceed at block 304, the method 300 continues to block 308 to determine whether the received utilization information of block 302 indicates utilization below a second threshold. If so, then resources may be de-assigned from the virtual machine at block 310. The de-assignment may include reducing assigned resources for the corresponding resources below the second threshold and/or decreasing a profile of the virtual machine, if not, then the method 300 may return to block 302 to receive additional resource utilization information for the virtual machine and continue to update the set of resources assigned to the virtual machine based on the additional resource utilization information.

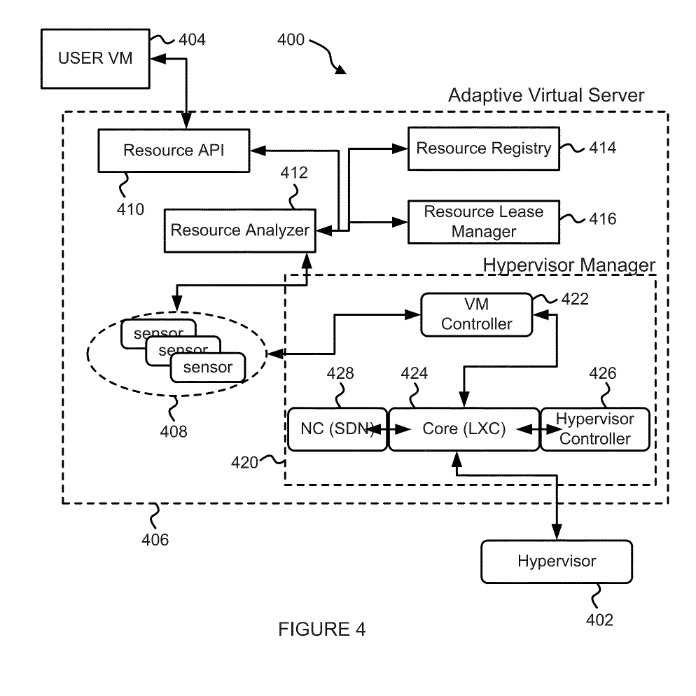

An adaptive virtual server may be used for managing virtual machines and hypervisors with dynamic resource assignment as described, for example, above with reference to FIG. 2 and FIG. 3. FIG. 4 is a block diagram illustrating an adaptive virtual server according to one embodiment of the disclosure. A system 400 may include an adaptive virtual server 406 coupled to a hypervisor 402 and a virtual machine 404. The virtual machine 404 may communicate with a resource application programming interface (API) for receiving resource utilization information from within the virtual machine 404. The resource utilization information may be provided to a resource analyzer 412 that determines resources to be assigned to the virtual machine 404, such as in accordance with the algorithms described above with reference to FIG. 2 and FIG. 3. The resource analyzer 412 may also receive utilization information from sensors 408 within the adaptive virtual server 406. The sensors 408 may, for example, determine an input/output (I/O) activity level within a virtual machine to indirectly estimate a resource utilization. When the resource analyzer 412 determines a new set of resources for the virtual machine 404, the resource analyzer 412 may poll a resource registry 414 to determine additional resources available to include in the new set of resources and/or return unused resources from the virtual machine 404 to the resource registry 414. The resource registry 414 may maintain a listing of resources available on the hypervisor 402 and other hypervisors (not shown). When a new set of resources are assigned by the resource analyzer 412, the resource analyzer 412 may communicate with a resource lease manager 416 to report the assignment of the new set of resources to the virtual machine 404 and obtain a lease on the new set of resources.

The adaptive virtual server 406 may include one or more hypervisor managers 420. The hypervisor manager 420 may include a hypervisor core 424 coupled to a hypervisor controller 426, a network controller 428, and a virtual machine controller 422. In one embodiment, one hypervisor manager 420 may manage multiple hypervisors for the adaptive virtual server 406. In another embodiment, one hypervisor manager 420 may manage a single hypervisor 402 and the adaptive virtual server 406 may include other hypervisor managers for managing other hypervisors (not shown).

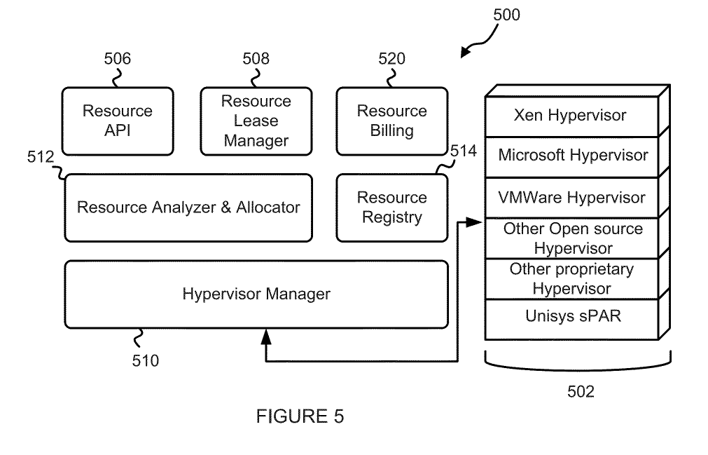

Components of the adaptive virtual server 406 may be in communication with the hypervisor manager 420. Additional details regarding the hypervisor manager 420 are described with reference to FIG. 5. FIG. 5 is a block diagram illustrating a hypervisor manager according to one embodiment of the disclosure. A hypervisor management communication system 500 may include a hypervisor manager 510 in communication with a resource analyzer and allocator module 512 and a resource registry module 514. The hypervisor manager 510 may also be in communication with a resource application program interface (API) module 506, a resource lease manager module 508, and/or a resource billing module 520 either directly or indirectly through the resource analyzer and allocator 512 and/or the resource registry 514.

In one embodiment, the resource API module 506 may be a RESTful-based API for a user interface (UI) to communicate with an adaptive virtual server and place a request for additional resources for a virtual machine.

In one embodiment, the resource billing module 520 may provide a user interface (UI) for displaying a current utilization of the resources and charges applied on those resources. Billing of the resources may be calculated per minute, day, month, and/or year through a configuration option. Once a billing time unit is selected by the user, the billing time unit may be non-revocable.

In one embodiment, a resource lease manager module 508 may apply lease properties on the resource and shortly before the lease expiry the lease manager module 508 may invoke a scheduler and validate a lease period and alert the user on the expiration of the lease. The resource lease manager module 508 may support releasing a resource before the lease expires. Further, a scheduler module (not shown) may bind a requested resource for a stated duration and monitor the resource until the lease expires.

In one embodiment, the resource registry module 514 may provide an interface to a database that tracks resources of a virtual machine and/or a hypervisor. For example, the database may store resource information (e.g., assigned and de-assigned status), store the resource origin information (hypervisor from which the resource is available), store the resource lease information, store scheduler information, store resource threshold limits (e.g., a first high threshold and a second low threshold), and/or store hypervisor sensor initiator details.

In one embodiment, the resource analyzer and allocator module 512 may have decision making capability to take action on assigning and/or de-assigning resources from hypervisors. When a threshold level, a lease expiration, and/or a de-assignment event occurs with respect to a resource, the resource analyzer and allocator module 512 may wait for a predetermined time period to distinguish between a spike and an actual need for the action. Further, the resource analyzer and allocator module 512 may monitor the threshold levels placed on the resources and may help a virtual machine manually and/or dynamically request additional resources. The resource analyzer and allocator module 512 may implement algorithms similar to those described above with reference to FIG. 2 and FIG. 3 for assigning and de-assigning resources. The resource analyzer and allocator module 512 may also or alternatively send notifications to a user when thresholds are reached. When a new set of resources is assigned by the resource analyzer and allocator module 512 to a virtual machine, a lease period, such as seven days or another value determined by the resource analyzer and allocator module 512, may be set by the resource lease manager module 508.

The resource analyzer and allocator module 512 may perform decision making for assigning resource for a virtual machine based on user requests for a virtual machine or user requests for resources. When a request is received, the resource analyzer and allocator module 512 may perform mining of the resource information across the hypervisors and select resources for the user. The resource analyzer and allocator module 512 may be configured, for example, by an administrator through a configuration file, such as an extensible markup language (XML) document. The configuration file may specify, for example, maximum and/or minimum resources available for assigning to a new set of resources, a hypervisor priority scheme, and/or a configurable time to wait before performing an action.

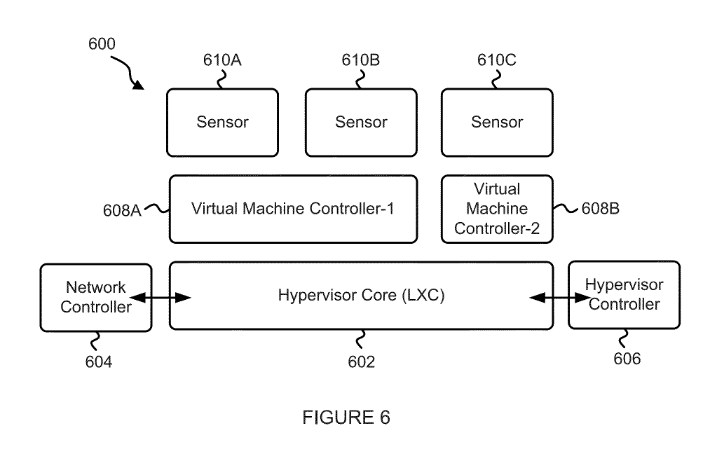

In one embodiment, the hypervisor manager may employ an actor model having hypervisor sensors communicating with a resource analyzer to improve fault tolerance and location transparency. In this model, the resource analyzer may be an actor that responds to a message that is received from the sensor, and the hypervisor manager may be an actor that responds to a message received from the resource analyzer. FIG. 6 is a block diagram illustrating communication between portions of a hypervisor manager and sensors according to one embodiment of the disclosure. A hypervisor manager system 600 may include a hypervisor core 602, such as a Linux core (LXC), in communication with a hypervisor controller 606 and a network controller 604. The hypervisor core 602 may communicate with virtual machine controllers 608A-13, which may communicate with sensors 610A-C. In the action model, the sensors 610A-C may be the worker programs that will monitor the resource utilization of the virtual machine and alert the hypervisor controller 606 to take action if the resource utilization crosses a threshold limits.

In one embodiment, the hypervisor core 602 may be implemented on Linux Containers (LXCs) that perform the functionality of managing the distributed computational resources and efficiently manage resources to a virtual machine pool. The hypervisor core 602 may be installed and configured as a paravirtualized hypervisor. The hypervisor core 602 may target external hypervisors to create virtual machines and commission the resources and itself maintain reference and computation information of those resource(s).

The hypervisor controller 606 may be an add-on module for the hypervisor core 602 configured to establish communication between external hypervisors (not shown) and the hypervisor core 602. The hypervisor controller 606 may hold the responsibility of allocating resources to the virtual machines created by the adaptive virtual server.

The network controller 604 may be used to assist the hypervisor core 602 to manage communication and perform computational operation between the hypervisor core 602 and an external hypervisor. In one embodiment, a virtual distributed network may be supported to manage the connections between the hypervisor core 602 and external hypervisors (not shown).

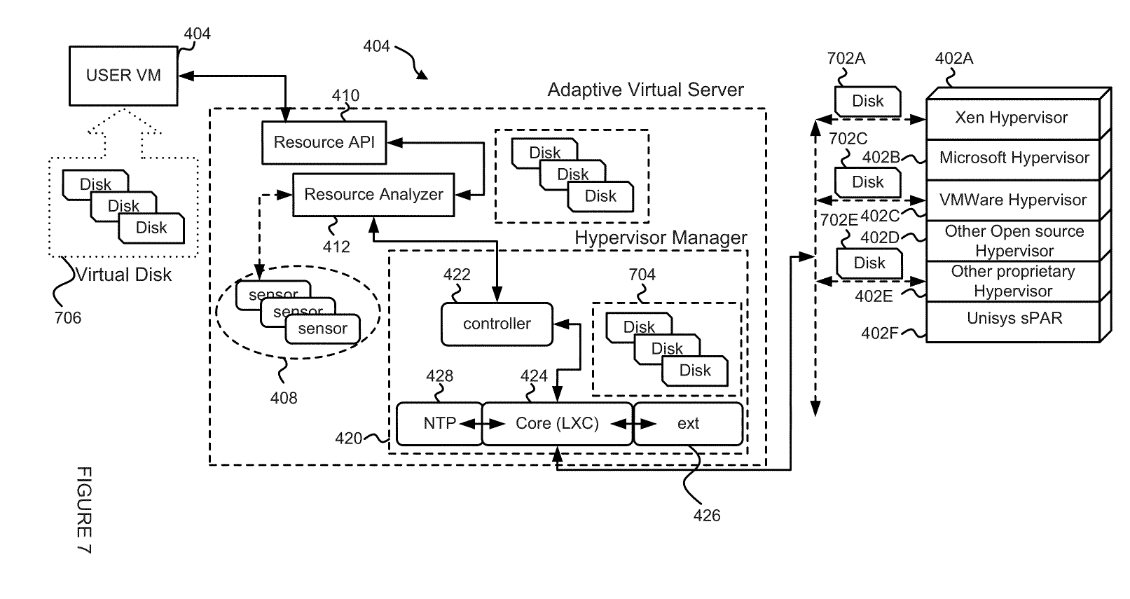

As described above network resources may be combined, or pooled, from multiple hypervisors and made available as a resource to a virtual machine. In one embodiment, disk storage space may be shared as shown in FIG. 7, although any resource, including RAM memory and processors, may also be shared similar to that shown in FIG. 7. FIG. 7 is a block diagram illustrating assigning of resources from multiple hypervisors to a virtual machine through an adaptive virtual server according to one embodiment of the disclosure. The system 400 is similar to that of FIG. 4. The hypervisors 402 may include hypervisors 402A-F, including hypervisors of different types, such as a Xen hypervisor 402A, a Microsoft hypervisor 402B, a VMWare hypervisor 402C, an other open source hypervisor 402D, an other proprietary hypervisor 402E, and/or a Unisys sPar hypervisor 402F.

In one example, the adaptive virtual server 406 may determine a set of resources for the virtual machine 404 to include an allotment of disk storage space. The disk storage space may be accumulated by the hypervisor manager 420 from disk storage space 702A, 702C, and 702E of hypervisors 402A, 402C, and 402E, respectively. The disk storage space may be accumulated as disks 704 for tracking by the hypervisor manager 420. The disks 704 may be presented to the virtual machine 404 as a virtual disk 406. The virtual machine 404 may read and write from the virtual disk 406 without knowledge of the location of the disks 702A, 702C, and 702E.

Other resources may be shared with the virtual machine 404 from the hypervisors 402A-F. A process for assigning, for example RAM memory, when a user and/or the adaptive virtual server 406 requests additional RAM, from multiple hypervisors may include: (1) placing the request through the resource API 410; (2) the resource analyzer 412 placing a request to a resource decision maker; (3) a resource decision maker placing a request to the virtual machine controller 422; (4) the virtual machine controller 422 creating sensors 408 to request and place call to the hypervisor controller 426 to provision the request; (5) when the provision is successful, the hypervisor controller 422 transferring the monitoring responsibility of the individual resources to the sensor 408; and (6) the resource analyzer 412 binding the requested resources as single unit and attach the single unit to the virtual machine 404.

Other scenarios for assigning resources to virtual machines may include assigning resources based on user requests. A user may create a virtual machine and assign resources to the virtual machine by selecting a particular hypervisors or hypervisor type. The user may have the choice of adding additional resources from the same hypervisor or from another hypervisor. For example, a user may place a request for a virtual machine on a hypervisor named Hyper-V and assign resources to the hypervisor from the hypervisor named Hyper-V.

Another scenario may include assigning resources to virtual machines without a user's knowledge. In this example, a user provides control to the adaptive virtual server (AVS) to make a best choice for virtual machine. The AVS may select a best hypervisor to create a virtual machine and select initial resources. A user may have the choice of requesting additional resources from the same or another hypervisor. For example, a user may place a request for a virtual machine, after which the AVS executes an internal analysis to select a hypervisor having best possible resources to support the user's needs.

A further scenario may include migrating a virtual machine from one hypervisor to another hypervisor with the hypervisor manager. Additionally, the AVS may support migration of existing virtual machine from one type of hypervisor to another type of hypervisor.

Yet another scenario may include supporting multiple storages by creating one single virtual storage for a virtual machine.

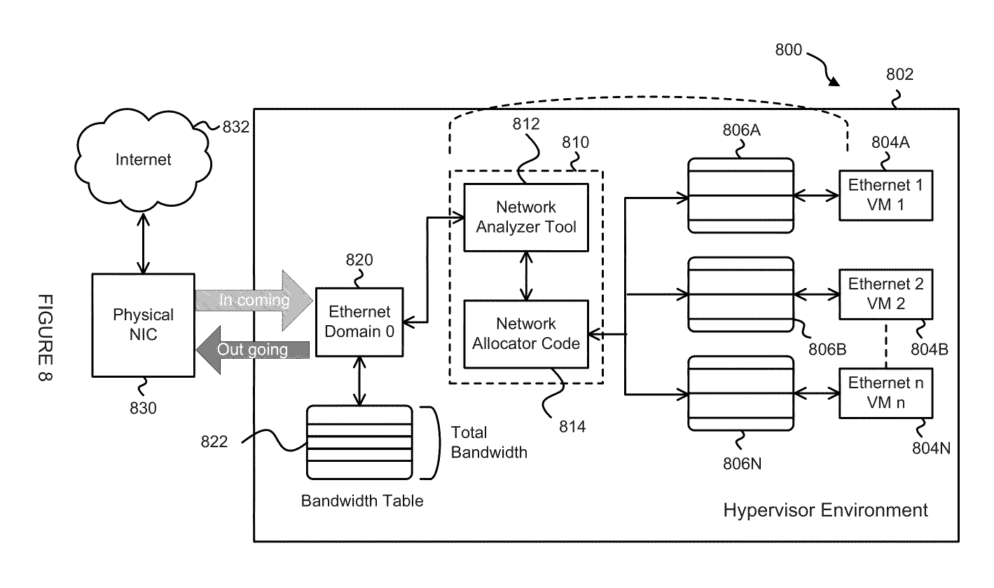

Referring back to FIG. 6, the network controller 604 may also be used to allocate bandwidth to the virtual machines through the hypervisor manager. FIG. 8 is a block diagram illustrating assigning bandwidth to virtual machines through an adaptive virtual server according to one embodiment of the disclosure. A system 800 may include a hypervisor environment 802 executing one or more virtual machines having virtual network connections 804A-N. Each of the network connections 804A-N may have an associated bandwidth table 806A-N. The bandwidth tables 806A-N may include entries corresponding to various available bandwidths available for configuring the network connections 804A-N. For example, the bandwidth table 806A may include a listing of entries 14 Mbps, 12 Mbps, 10 Mbps, 8 Mbps, 6 Mbps, and 4 Mbps. The virtual network connections 804A-804N may communicate through a network connection 820 to a physical network connection 830 and to a network 832, such as the Internet, at a maximum rate defined by a selected entry from the bandwidth tables 806A-N, respectively. A network analyzer tool 812 and a network allocator code 814 may analyze network traffic and determine an appropriate bandwidth allotment for each of the network connections 804A-N selected from available bandwidth settings in the tables 806A-N as a fraction of a total bandwidth available for the network connection 820 as set by bandwidth table 822. The network tools 810 may be, for example, integrated with the adaptive virtual server 406 of FIG. 4. The network tools 810 may reevaluate and select new bandwidth limits for the virtual network connections 804A-IN. For example, a bandwidth of 10 Mbps may be set for the virtual network connection 804A and later updated to 12 Mbps.

In one embodiment, if enough bandwidth is available to satisfy the virtual machines corresponding to the virtual network connections 804-N, then the network tools 810 may increase the bandwidth of virtual machines having a network utilization equal to an allocated bandwidth when the allocated bandwidth is less than a maximum limit of the virtual machine set in the bandwidth table. Then, the network tools 810 may decrease the corresponding free bandwidth available at the network connection 820.

In another embodiment, if not enough bandwidth is available to satisfy all virtual machines, then the network tools 810 may increase the bandwidth of virtual machines by an incremental bandwidth amount equal to (an actual bandwidth required by the virtual machine) divided by (a total bandwidth required by all virtual machines) multiplied by a total free available bandwidth at the network connection 820. That is, the bandwidth for the virtual machines may each be increased proportionally.

In a further embodiment, if network utilization of a virtual machine is less than a predetermined amount (e.g., 80%) of the allocated bandwidth to the virtual machine and the allocated bandwidth is greater than a minimum limit, then the network toots 810 may decrease the allocated bandwidth for the virtual machine and increase the free bandwidth available at the network connection 820. That is, a virtual machine not using all assigned bandwidth may have its bandwidth decreased.

The adjustments of network bandwidth as described may be executed by the network controller 604 of FIG. 6 based on network utilization of the virtual machines, such that the bandwidth tables 806A-N are created dynamically. In one example, assume a virtual machine has a 10 Mbps bandwidth. The network tools 810 may increase and decrease the bandwidth by redirecting the traffic to different bandwidth classes based on network utilization of the virtual machine. If not enough bandwidth is available to satisfy all virtual machines then the bandwidth of the virtual machines may be increased using a formula such as [Additional Incremental Bandwidth=(actual bandwidth required by the virtual machine/total bandwidth required by all virtual machines)*total free available bandwidth]. When network utilization is equal to an allocated bandwidth and allocated bandwidth less than a maximum limit of the virtual machine, the corresponding free bandwidth at the network controller 820 may be decreased.

In one embodiment, a ceiling limit may be applied to the network bandwidth for assignment to a virtual machine. For example, a virtual machine may have a network allocation of 10 Mbps and an upper ceiling of 14 Mbps. If network utilization of the virtual machine is less than 80% of the allocated bandwidth and the allocated bandwidth is larger than a minimum limit, then the allocated bandwidth may be decreased to 8 Mbps and the free bandwidth available at the network connection 820 may be increased by a corresponding amount.

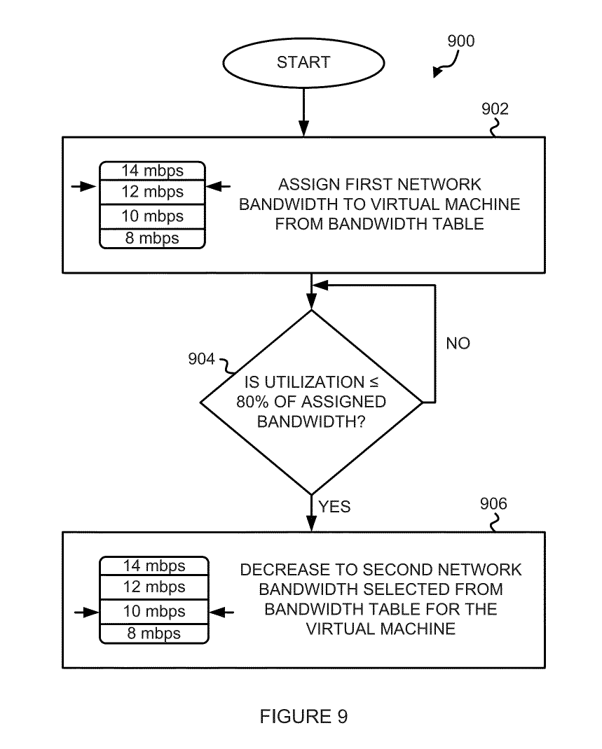

To show the operation of the bandwidth tables, the decreasing of allocated network bandwidth in a virtual machine is shown in FIG. 9. FIG. 9 is a flow chart illustrating a method of assigning bandwidth to a virtual machine according to one embodiment of the disclosure. A method 900 begins at block 902 with assigning a first network bandwidth from a bandwidth table to a virtual machine. For example, a bandwidth of 12 Mbps may be selected from a table listing 14 Mbps, 12 Mbps, 10 Mbps, and 8 Mbps. Then, at block 904, it is determined whether the virtual machine is utilizing less than 80% of the assigned bandwidth. If yes, then the method 900 proceeds to block 906 to decrease the virtual machine to a second network bandwidth selected from the bandwidth table lower than the first network bandwidth. For example, a bandwidth of 10 Mbps may be selected from the able.

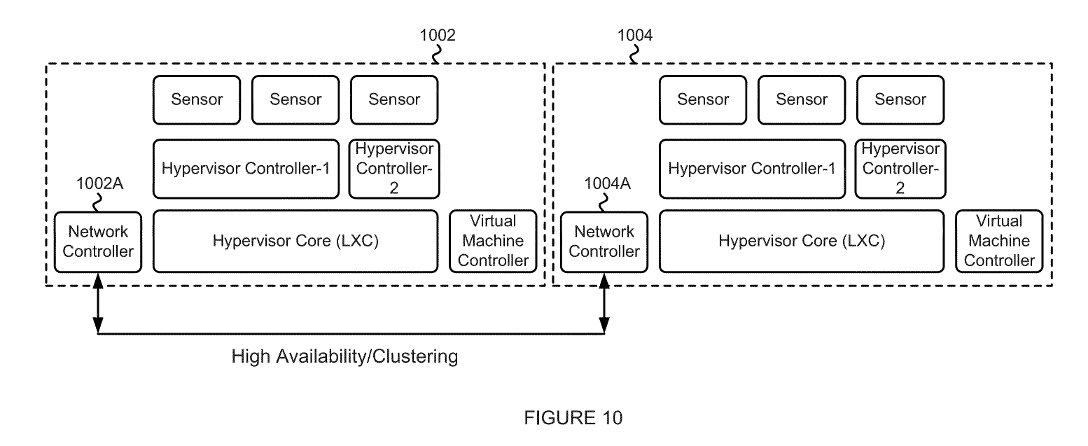

Several hypervisor managers may be clustered to improve availability and/or performance. FIG. 10 is a block diagram illustrating clustering of hypervisor managers according to one embodiment. A first hypervisor manager 1002 may be coupled to a second hypervisor manager 1004 through network controllers 1002A and 1004A, respectively. Clustering may allow one of the hypervisor managers 1002 and 1004 to fail and the other of the hypervisor managers 1002 and 1004 to take over management of virtual machines assigned to the failed hypervisor manager. Additionally, clustering may allow hypervisors at different locations to cooperate and manage virtual machines and hypervisors at different locations. For example, the hypervisor manager 1002 may manage a plurality of hypervisors in New York, N.Y. while the hypervisor manager 1004 may manage a plurality of hypervisors in Los Angeles, Calif. The network controllers 1002A and 1004A may handle requests for clustering operation between two or more instances of adaptive virtual servers. The network controllers 1002A and 1004A may also handle computation of client/server processes using a collaborative network computing model. In this model nodes may share processing capabilities apart from sharing data, resources, and other services. The clustering of hypervisor managers 1002 and 1004 may increase computation speed and increase the response speed of a request.

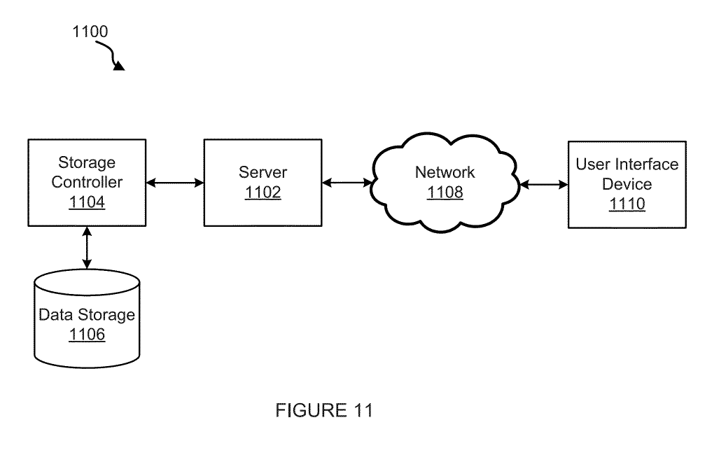

FIG. 11 illustrates one embodiment of a system 1100 for an information system, including an adaptive virtual server. The system 1100 may include a server 1102, a data storage device 1106, a network 1108, and a user interface device 1110. In a further embodiment, the system 1100 may include a storage controller 1104, or storage server configured to manage data communications between the data storage device 1106 and the server 1102 or other components in communication with the network 1108. In an alternative embodiment, the storage controller 1204 may be coupled to the network 1108.

In one embodiment, the user interface device 1110 is referred to broadly and is intended to encompass a suitable processor-based device such as a desktop computer, a laptop computer, a personal digital assistant (PDA) or tablet computer, a smartphone, or other mobile communication device having access to the network 1108. In a further embodiment, the user interface device 1110 may access the Internet or other wide area or local area network to access a web application or web service hosted by the server 1102 and may provide a user interface for controlling the adaptive virtual server.

The network 1108 may facilitate communications of data between the server 1102 and the user interface device 1110. The network 1108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

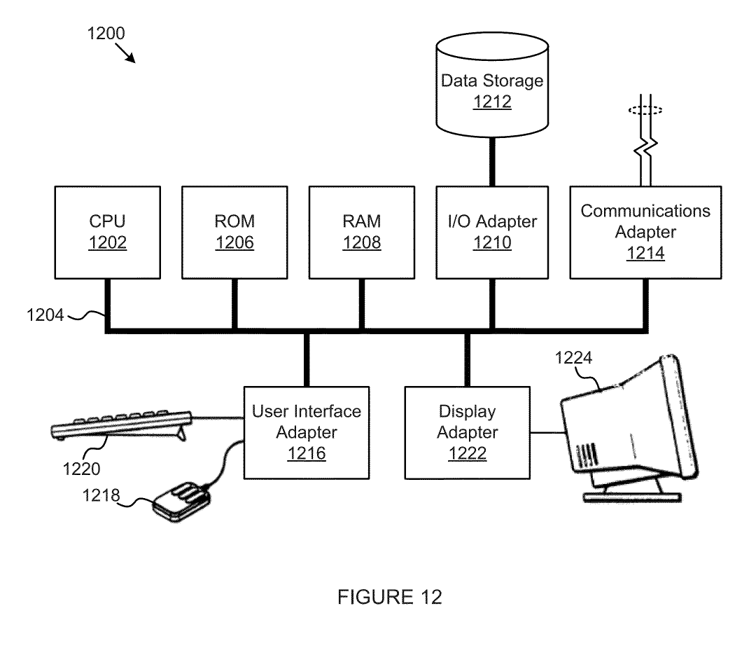

FIG. 12 illustrates a computer system 1200 adapted according to certain embodiments of the server 1102 and/or the user interface device 1110. The central processing unit (“CPU”) 1202 is coupled to the system bus 1204. The CPU 1202 may be a general purpose CPU or microprocessor, graphics processing unit (“GPU”), and/or microcontroller. The present embodiments are not restricted by the architecture of the CPU 1202 so long as the CPU 1202, whether directly or indirectly, supports the operations as described herein. The CPU 1202 may execute the various logical instructions according to the present embodiments.

The computer system 1200 may also include random access memory (RAM) 1208, which may be synchronous RAM (SRAM), dynamic RAM (DRAM), synchronous dynamic RAM (SDRAM), or the like. The computer system 1200 may utilize RAM 1208 to store the various data structures used by a software application. The computer system 1200 may also include read only memory (ROM) 1206 which may be PROM, EPROM, EEPROM, optical storage, or the like. The ROM may store configuration information for booting the computer system 1200. The RAM 1208 and the ROM 1206 hold user and system data, and both the RAM 1208 and the ROM 1206 may be randomly accessed.

The computer system 1200 may also include an input/output (I/O) adapter 1210, a communications adapter 1214, a user interface adapter 1216, and a display adapter 1222. The I/O adapter 1210 and/or the user interface adapter 1216 may, in certain embodiments, enable a user to interact with the computer system 1200. In a further embodiment, the display adapter 1222 may display a graphical user interface (GUI) associated with a software or web-based application on a display device 1224, such as a monitor or touch screen.

The I/O adapter 1210 may couple one or more storage devices 1212, such as one or more of a hard drive, a solid state storage device, a flash drive, a compact disc (CD) drive, a floppy disk drive, and a tape drive, to the computer system 1200. According to one embodiment, the data storage 1212 may be a separate server coupled to the computer system 1200 through a network connection to the I/O adapter 1210. The communications adapter 1214 may be adapted to couple the computer system 1200 to the network 1108, which may be one or more of a LAN, WAN, and/or the Internet. The user interface adapter 1216 couples user input devices, such as a keyboard 1220, a pointing device 1218, and/or a touch screen (not shown) to the computer system 1200. The keyboard 1220 may be an on-screen keyboard displayed on a touch panel. The display adapter 1222 may be driven by the CPU 1202 to control the display on the display device 1224. Any of the devices 1202-1222 may be physical and/or logical.

The applications of the present disclosure are not limited to the architecture of computer system 1200. Rather the computer system 1200 is provided as an example of one type of computing device that may be adapted to perform the functions of the server 1102 and/or the user interface device 1110. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus, comprising:
a hypervisor manager in communication with at least one virtual machine and at least one hypervisor,
wherein the hypervisor manager is configured to assign resources from the at least one hypervisor to the at least one virtual machine, and
wherein the hypervisor manager comprises:
a resource registry module configured to store a listing of resources available on the at least one hypervisor; and
a resource analyzer module configured to receive resource utilization information of the at least one virtual machine.

2. The apparatus of claim 1, further comprising a resource allocator module configured to instruct the at least one hypervisor to modify the assigned resources for the at least one virtual machine.

3. The apparatus of claim 2, wherein the resource analyzer module is configured to analyze the received resource utilization information to determine when the resource utilization indicates resource utilization for at least one resource exceeds a first threshold or decreases below a second threshold.

4. The apparatus of claim 3, wherein the received resource utilization information comprises at least one of a processor utilization, a memory utilization, and a storage utilization.

5. The apparatus of claim 4, wherein the resource allocator module is configured to:
assign additional resources from the at least one hypervisor listed in the resource registry to the at least one virtual machine when the received utilization information indicates resource utilization for at least one resource reaches the first threshold; and
de-assign resources from the at least one virtual machine when the received utilization information indicates resource utilization for at least one resource decreases below the second threshold.

6. The apparatus of claim 5, wherein the resource allocator module is configured to read the first threshold and the second threshold from an extensible markup language (XML) document.

7. The apparatus of claim 3, wherein the hypervisor manager is further configured to alert an administrator when the received resource utilization information indicates the at least one virtual machine reached a first threshold.

8. The apparatus of claim 1, further comprising at least one sensor module executing in the at least one virtual machine, wherein the hypervisor manager is in communication with the at least one virtual machine through the at least one sensor module.

9. The apparatus of claim 1, further comprising a hypervisor core, wherein the hypervisor manager executes on the hypervisor core.

10. The apparatus of claim 9, further comprising a hypervisor controller coupled to the hypervisor core, wherein the hypervisor controller is configured to couple the hypervisor core to the at least one hypervisor.

11. The apparatus of claim 9, further comprising a network controller coupled to the hypervisor core, wherein the network controller is configured to allocate bandwidth to the at least one virtual machine based, at least in part, on received resource utilization information for the at least one virtual machine.

12. The apparatus of claim 1, further comprising a resource API module configured to allow a interface to communicate with the hypervisor manager to place a request for additional resources for the at least one virtual machine.

13. The apparatus of claim 1, further comprising a resource lease manage module configured to apply lease properties, including an expiration, on the assigned resources.

14. The apparatus of claim 1, further comprising a resource billing module configured to provide a user interface for displaying at least the assigned resources and charges applied on the assigned resources.
